(19) United States
(12) Patent Application Publication
(10) Pub. No.: US 2024/0186810 A1
(43) Pub. Date: Jun. 6, 2024

(54) POWER TOOL SYSTEM INCLUDING TETHERED BATTERY PACK

(71) Applicant: MILWAUKEE ELECTRIC TOOL CORPORATION, Brookfield, WI (US)

(72) Inventors: Benjamin R. Suhr, Milwaukee, WI (US); Douglas R. Fieldbinder, Greendale, WI (US)

(21) Appl. No.: 18/524,504

(22) Filed: Nov. 30, 2023

Related U.S. Application Data
(60) Provisional application No. 63/385,669, filed on Dec. 1, 2022.

(51) Int. Cl. H02J 7/00

(52) U.S. Cl. CPC H02J 7/0063; H02J 7/0044; H02J 7/007182; H02J 2207/20

(57) ABSTRACT

A power tool system includes a battery pack having a first voltage. The battery pack includes a power output interface, a plurality of battery cells configured to output the first voltage, and a voltage boosting circuit electrically connected to the plurality of battery cells. The voltage boosting circuit receives the first voltage and outputs a second voltage to the power output interface. The power tool system also includes a power tool. The power tool includes a motor, a power input interface configured to receive the second voltage, and a voltage reduction circuit. The voltage reduction circuit receives the second voltage from the power input interface and provides a third voltage to the motor. The power tool system further includes a power cable configured to transmit power from the power output interface of the battery pack to the power input interface of the power tool.

### RELATED APPLICATIONS

This application claims the benefit of U.S. Provisional Patent Application No. 63/385,669, filed Dec. 1, 2022, the entire content of which is hereby incorporated by reference.

### FIELD

Embodiments described herein relate to power tool systems.

### SUMMARY

Power tool systems described herein include a battery pack having a first voltage. The battery pack includes a power output interface, a plurality of battery cells configured to output a first voltage, and a voltage boosting circuit electrically connected to the plurality of battery cells. The voltage boosting circuit receives the first voltage and outputs a second voltage to the power output interface. The power tool system also includes a power tool. The power tool includes a motor, a power input interface configured to receive the second voltage, and a voltage reduction circuit. The voltage reduction circuit receives the second voltage from the power input interface and provides a third voltage to the motor. The power tool system further includes a power cable configured to transmit power from the power output interface of the battery pack to the power input interface of the power tool.

In one aspect, the battery pack further includes a battery pack controller configured to receive a signal from the power tool via the power cable, the signal indicative of the value of the second voltage, determine the second voltage based on the signal, and control the voltage boosting circuit to output the second voltage.

In another aspect, the battery pack further includes a battery pack controller configured to determine whether the battery pack is directly electrically connected to the power tool or electrically connected to the power tool via the power cable, and control, in response to determining that the battery pack is electrically connected to the power tool via the power cable, the voltage boosting circuit to output the second voltage such that the second voltage is greater than the first voltage.

In another aspect, a battery pack controller is configured to control, in response to determining that the battery pack is directly electrically connected to the power tool, the voltage boosting circuit to output the second voltage such that the second voltage is approximately equal to the first voltage of the battery pack.

In another aspect, the power tool system further includes a communication network, and the battery pack further includes a battery pack controller configured to receive a user input via the communication network, determine the second voltage of the battery pack based on the user input, and control the voltage boosting circuit to output the second voltage.

In another aspect, the third voltage is approximately equal to the first voltage of the battery pack.

In another aspect, the second voltage is greater than the first voltage, and the third voltage is less than the second voltage.

In another aspect, the third voltage is approximately equal to a nominal voltage of the power tool.

In another aspect, the first voltage is approximately equal to a nominal voltage of the battery pack.

In another aspect, a first end of the power cable is removably connectable to the power output interface of the battery pack, and a second end of the power cable is removably connectable to the power input interface of the power tool.

Power tool systems described herein include a battery pack including a power output interface, a plurality of battery cells collectively configured to output a first voltage, and a voltage boosting circuit electrically connected between the plurality of battery cells and the power output interface. The voltage boosting circuit is configured to receive the first voltage and output a second voltage. Power tool systems described herein also include a power tool including a motor, a power input interface configured to receive a third voltage, and a voltage reduction circuit electrically connected between the power input interface and the motor. The voltage reduction circuit is configured to receive the third voltage from the power input interface and provide a fourth voltage to the motor. Power tool systems described herein also include a power cable configured to transmit power from the power output interface of the battery pack to the power input interface of the power tool.

In one aspect, the third voltage is less than or equal to the second voltage and greater than the first voltage.

In another aspect, the second voltage is greater than the first voltage and the fourth voltage.

In another aspect, the fourth voltage is approximately equal to the first voltage.

Methods described herein include outputting, with a plurality of battery cells in a battery pack, a first voltage to a voltage boosting circuit, receiving, with the voltage boosting circuit, the first voltage, outputting, with the voltage boosting circuit, a second voltage to a power output interface of the battery pack, transmitting power from the power output interface of the battery pack to a power input interface of a power tool, receiving, with a voltage reduction circuit of the power tool, the second voltage from the power input interface, outputting, with the voltage reduction circuit, a third voltage to a motor of the power tool, and driving the motor with the third voltage.

In one aspect, the method further includes receiving, with a battery pack controller, a signal from the power tool via the power cable, the signal indicative of a sensed value of the third voltage, and determining, with the battery pack controller, the second voltage based on the signal; and controlling the voltage boosting circuit to output the second voltage.

In another aspect, the method further includes receiving, with a battery pack controller, a command from the power tool via the power cable to modify the second voltage, and controlling, with the battery pack controller, the voltage boosting circuit to output a modified second voltage based on the command.

In another aspect, the method further includes determining, with a battery pack controller, whether the battery pack is directly electrically connected to the power tool or electrically connected to the power tool via the power cable, and controlling, with the battery pack controller in response to determining that the battery pack is electrically connected to the power tool via the power cable, the voltage boosting circuit to output the second voltage such that the second voltage is greater than the first voltage.

In another aspect, the method further includes controlling, in response to determining that the battery pack is directly electrically connected to the power tool, the voltage boosting circuit to output the second voltage such that the second voltage is approximately equal to the first voltage of the battery pack.

In another aspect, the method further includes receiving, with a battery pack controller, a user input via a communication network, determining, with the battery pack controller, the second voltage of the battery pack based on the user input, and controlling, with the battery pack controller, the voltage boosting circuit to output the second voltage.

Before any embodiments are explained in detail, it is to be understood that the embodiments are not limited in application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Other aspects of the embodiments will become apparent by consideration of the detailed description and accompanying drawings.

### BRIEF DESCRIPTION OF THE DRAWINGS

FIG. 1 schematically illustrates a power tool system including a battery pack and a power tool, according to some embodiments.

FIG. 2 schematically illustrates the battery pack of FIG. 1, according to some embodiments.

FIG. 3 schematically illustrates the power tool of FIG. 1, according to some embodiments.

FIG. 4 illustrates a method for controlling a battery pack, according to some embodiments.

FIG. 5 illustrates a method for controlling a power tool, according to some embodiments.

### DETAILED DESCRIPTION

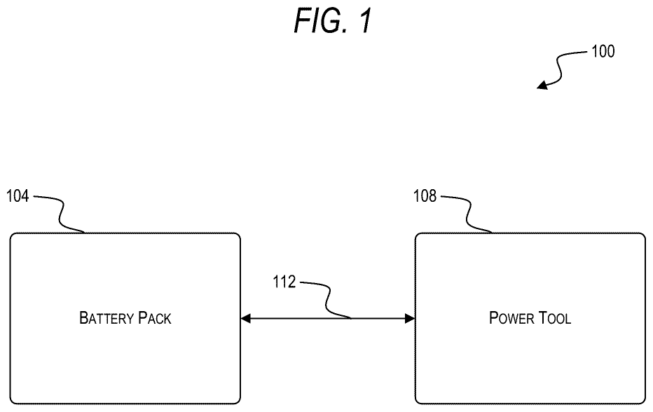

FIG. 1 schematically illustrates a power tool system 100. The system 100 includes a battery pack 104 and a power tool 108. The battery pack 104 is removably tethered to the power tool 108 with a power cable 112. The power cable 112 electrically connects the battery pack 104 to the power tool 108, and transmits power output by the battery pack 104 to the power tool 108. The power cable 112 enables operation of the power tool 108 remote from the battery pack 104, thus reducing the weight of the power tool 108 and increasing maneuverability of the power tool 108. The power cable 112 may alternatively be referred to herein as a power tether.

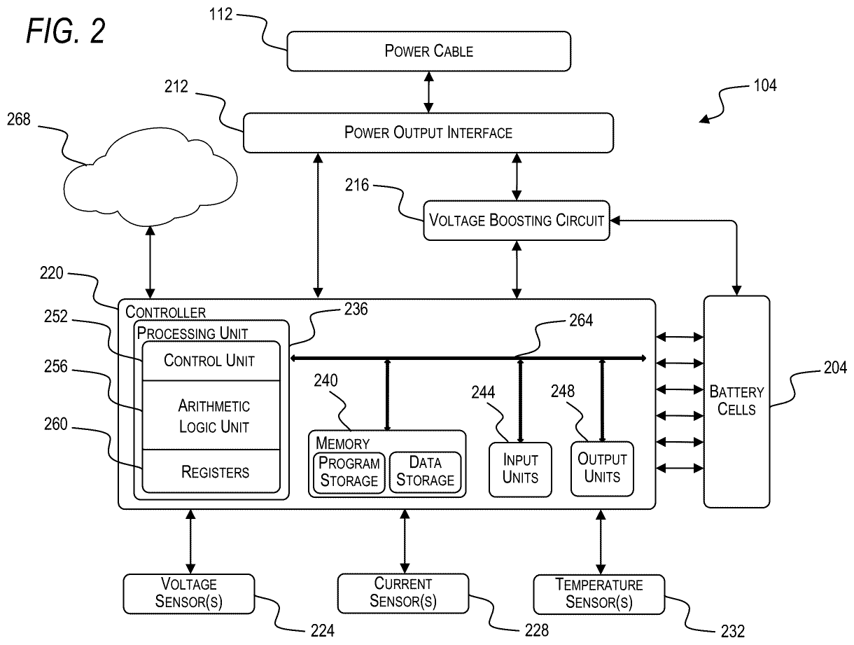

FIG. 2 schematically illustrates the battery pack 104, according to some embodiments. The battery pack 104 includes a housing defining an internal cavity in which a plurality of battery cells 204 are supported. Each battery cell may have a nominal voltage between about 3 V and about 5 V and may have a nominal capacity between about 2 Ah and about 10 Ah (in some cases, between about 3 Ah and about 5 Ah). The battery cells 204 may be any rechargeable battery cell chemistry type, such as, for example, lithium (Li), lithium-ion (Li-ion), other lithium-based chemistry, nickel-cadmium (NiCd), nickel-metal hydride (NiMH), etc. In some embodiments, the battery pack 104 has a nominal voltage of between about 12V DC and 120V DC (e.g., 18V, 36V, 40V, 72V DC, 80V DC, 120V DC, etc.). In some embodiments, the battery cells are cylindrical battery cells having a diameter (e.g., 21 mm) and a length (e.g., 70 mm). In other embodiments, the battery cells are pouch battery cells. In some embodiments, the battery cells 204 are operable to output a sustained operating discharge current of between about 40 Amperes and about 200 Amperes.

The plurality of battery cells 204 may be connected in series, parallel, or combination series-parallel to provide the desired electrical characteristics (e.g., nominal voltage, current output, current capacity, power capacity, etc.) of the battery pack 104. The plurality of battery cells 204 output power to a power output interface 212. The power output interface 212 includes, for example, a port to which the power cable 112 is physically and electrically connectable in order to transmit power from the plurality of battery cells 204 to the power tool 108. In some embodiments, the battery pack 104 is also directly connectable to the power tool 108 via the power output interface 212.

Voltage drops may occur as power is transmitted from the battery pack 104 to the power tool 108 over the power cable 112, and in particular, as the length of the power cable 112 increases. These voltage drops may result in the power tool 108 experiencing a “brown-out” condition (e.g., an insufficient supply of voltage for a period of time). Additionally, transmitting high current over the power cable 112 may result in the power cable 112 overheating or other losses.

In order to compensate for power losses and to prevent the power cable 112 from overheating, a voltage boosting circuit 216 (e.g., a boost converter) is electrically connected between the plurality of battery cells 204 and the power output interface 212. The plurality of battery cells 204 are configured to collectively output a first voltage (e.g., the nominal voltage of the battery pack 104) to the voltage boosting circuit 216. The voltage boosting circuit 216 is configured to boost, or step up, the first voltage and output a second voltage to the power output interface 212. The second voltage is greater than the first voltage. In some embodiments, power is transmitted at a high voltage and low current. For example, the voltage boosting circuit 216 may boost the first voltage to a predetermined amount (e.g., 20V, 50V, 100V, 200V, 500V, etc.).

With continued reference to FIG. 2, a generalized schematic of a controller 220 included in the battery pack 104 is illustrated. The controller 220 is electrically and/or communicatively connected to a variety of components of the battery pack 104. For example, the illustrated controller 220 is electrically connected to the plurality of battery cells 204, one or more voltage sensors 224, one or more current sensors 228, one or more temperature sensors 232, the power output interface 212, and the voltage boosting circuit 216. The controller 220 includes combinations of hardware and software that are operable to, among other things, control the operation of the battery pack 104 and monitor the operation of the battery pack 104.

The controller 220 includes a plurality of electrical and electronic components that provide power, operational control, and protection to the components and modules within the controller 220 and/or the battery pack 104. For example, the controller 220 includes, among other things, a processing unit 236 (e.g., a microprocessor, a microcontroller, an electronic processor, an electronic controller, or another suitable programmable device), a memory 240, input units 244, and output units 248. The processing unit 236 includes, among other things, a control unit 252, an arithmetic logic unit (“ALU”) 256, and a plurality of registers 260 (shown as a group of registers in FIG. 2), and is implemented using a known computer architecture (e.g., a modified Harvard architecture, a von Neumann architecture, etc.). The processing unit 236, the memory 240, the input units 244, and the output units 248, as well as the various modules or circuits connected to the controller 220 are connected by one or more control and/or data buses (e.g., common bus 264). The control and/or data buses are shown generally in FIG. 2 for illustrative purposes. The use of one or more control and/or data buses for the interconnection between and communication among the various modules, circuits, and components would be known to a person skilled in the art in view of the embodiments described herein.

The memory 240 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 236 is connected to the memory 240 and executes software instructions that are capable of being stored in a RAM of the memory 240 (e.g., during execution), a ROM of the memory 240 (e.g., on a generally permanent basis), or another non-transitory computer readable medium such as another memory or a disc. Software included in the implementation of the battery pack 104 can be stored in the memory 240 of the controller 220. The software includes, for example, firmware, one or more applications, program data, filters, rules, one or more program modules, and other executable instructions. The controller 220 is configured to retrieve from the memory 240 and execute, among other things, instructions related to the control processes and methods described herein. In other constructions, the controller 220 includes additional, fewer, or different components.

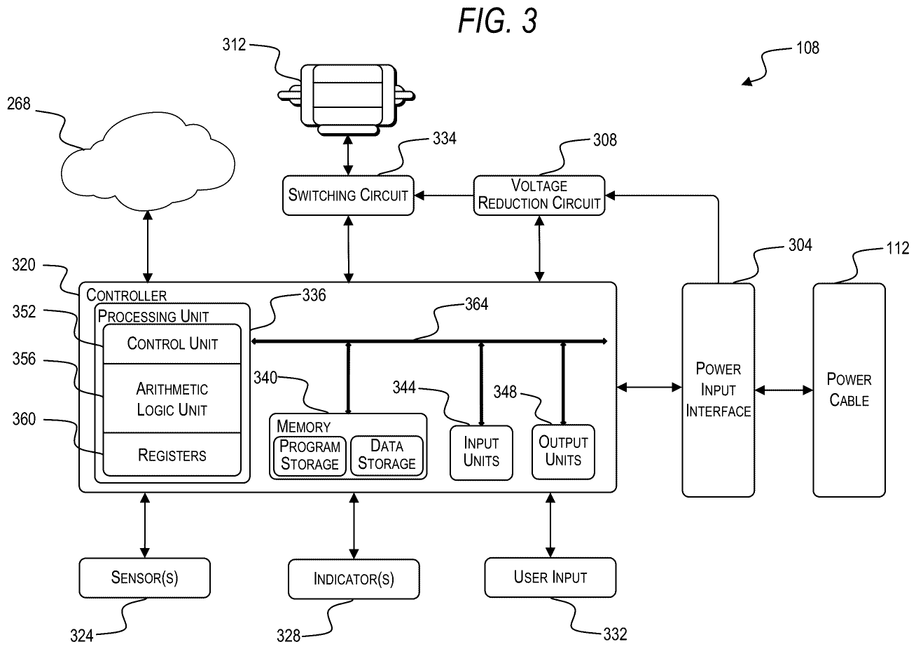

The controller 220 may implement a variety of methods to determine a desired output voltage of the battery pack 104. In some embodiments, the controller 220 is configured to transmit or receive a communication signal from the power tool 108 via the power cable 112 and the power output interface 212. For example, the controller 220 may determine the desired output voltage based on a signal received from the power tool 108 indicative of a voltage sensed at a power input interface (e.g., the power input interface 304 illustrated in FIG. 3) of the power tool 108. Because of power losses over the power cable 112, the voltage received by the power tool 108 via the power cable 112 may be less than the voltage output by the battery pack 104 at the power output interface 212. Based on the signal indicative of the voltage sensed at the power input interface of the power tool 108, the controller 220 may control the voltage boosting circuit 216 to increase or decrease the amount that the voltage boosting circuit 216 boosts the first voltage output by the plurality of battery cells 204.

In some instances, the controller 220 is configured to determine the desired output voltage based on a command received from the power tool 108 to modify (e.g., increase or decrease) voltage received at a power input interface (e.g., the power input interface 304 illustrated in FIG. 3) of the power tool 108. Based on the command received from the power tool 108, the controller 220 may control the voltage boosting circuit 216 to modify (e.g., increase or decrease) the amount that the voltage boosting circuit 216 boosts the first voltage output by the plurality of battery cells 204.

In some embodiments, the controller 220 is configured to detect whether the battery pack 104 is electrically connected to the power tool 108 via the power cable 112, or is directly electrically connected to the power tool 108 (e.g., connected to a battery pack interface of the power tool 108). In response to determining that the battery pack 104 is connected to the power tool 108 via the power cable 112, the controller 220 controls the voltage boosting circuit 216 to boost the first voltage to a predetermined second voltage. In contrast, in response to determining that the battery pack 104 is directly connected to the power tool 108, the controller 220 may control the voltage boosting circuit 216 not to boost the first voltage, and to instead output a voltage approximately equal to the nominal voltage of the battery pack 104 (e.g., unity gain).

In some embodiments, the controller 220 is configured to connect to a wireless communication network 268. The communication network may include a short range network, for example, a Bluetooth network, a Wi-Fi network or the like, or a long range network, for example, the Internet, a cellular network, or the like. A user may monitor a status of the battery pack 104 or control operation of the battery pack 104 using a mobile device connected to the communication network 268. For example, the controller 220 may receive from the user, via the communication network 268, a signal indicative of an amount to boost the first voltage or a signal indicative of desired value of the second voltage. The controller 220 then controls the voltage boosting circuit 216 to boost the first voltage to the second voltage based on the signal. In some embodiments, the controller 220 receives a signal indicative of a size of the power cable 112 (e.g., a gauge of the power cable 112 and/or a length of the power cable 112) and controls the voltage boosting circuit 216 to boost the first voltage to the second voltage based on the signal.

FIG. 3 schematically illustrates the power tool 108, according to some embodiments. The power tool 108 includes a power input interface 304. The power input interface 304 includes, for example, a port to which the power cable 112 is physically and electrically connectable in order to transmit power from the plurality of battery cells 204 to the power tool 108. The power input interface 304 receives the second voltage via the power cable 112. The second voltage may be greater than the nominal voltage of the battery pack 104 but less than or equal to the second voltage output at the power output interface 212 of the battery pack 104 as a result of power losses that occur during transmission of power over the power cable 112. In some embodiments, the power input interface 304 can be considered to instead receive a third voltage via the power cable 112 to account for potential losses during power transfer. In some embodiments, boosting the voltage output from the battery pack 104 substantially reduces losses that occur when power is transferred to the power tool 108.

The power tool 108 also includes a voltage reduction circuit 308 (e.g., a buck converter) electrically connected to the power input interface 304, and a motor 312 electrically connected to the voltage reduction circuit 308. The voltage reduction circuit 308 receives the second voltage from the power input interface 304 and reduces, or steps down, the second voltage to a third voltage. The third voltage may be, for example, the nominal voltage of the battery pack 104 and/or the nominal voltage of the power tool 108. The voltage reduction circuit 308 then provides the third voltage to the motor 312. In embodiments where the power input interface 304 is considered to receive a third voltage, voltage reduction circuit 308 would produce a fourth voltage.

With continued reference to FIG. 3, a generalized schematic of a controller 320 included in the power tool 108 is illustrated. The controller 320 is electrically and/or communicatively connected to a variety of components of the power tool 108. For example, the illustrated controller 320 is electrically connected to the power input interface 304, one or more sensors 324 (e.g., one or more voltage sensors, one or more current sensors, one or more temperature sensors, etc.), one or more indicators 328, a user input interface 332 (e.g., a tool trigger, one or more buttons, one or more switches, etc.), a switching circuit 334 (e.g., including a plurality of switching FETs), and the voltage reduction circuit 308. The controller 320 includes combinations of hardware and software that are operable to, among other things, control the operation of the power tool 108 and monitor the operation of the power tool 108.

The controller 320 includes a plurality of electrical and electronic components that provide power, operational control, and protection to the components and modules within the controller 320 and/or the power tool 108. For example, the controller 320 includes, among other things, a processing unit 336 (e.g., a microprocessor, a microcontroller, an electronic processor, an electronic controller, or another suitable programmable device), a memory 340, input units 344, and output units 348. The processing unit 336 includes, among other things, a control unit 352, an arithmetic logic unit (“ALU”) 356, and a plurality of registers 360 (shown as a group of registers in FIG. 3), and is implemented using a known computer architecture (e.g., a modified Harvard architecture, a von Neumann architecture, etc.). The processing unit 336, the memory 340, the input units 344, and the output units 348, as well as the various modules or circuits connected to the controller 320 are connected by one or more control and/or data buses (e.g., common bus 364). The control and/or data buses are shown generally in FIG. 3 for illustrative purposes. The use of one or more control and/or data buses for the interconnection between and communication among the various modules, circuits, and components would be known to a person skilled in the art in view of the embodiments described herein.

The memory 340 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 336 is connected to the memory 340 and executes software instructions that are capable of being stored in a RAM of the memory 340 (e.g., during execution), a ROM of the memory 340 (e.g., on a generally permanent basis), or another non-transitory computer readable medium such as another memory or a disc. Software included in the implementation of the power tool 108 can be stored in the memory 340 of the controller 320. The software includes, for example, firmware, one or more applications, program data, filters, rules, one or more program modules, and other executable instructions. The controller 320 is configured to retrieve from the memory 340 and execute, among other things, instructions related to the control processes and methods described herein. In other constructions, the controller 320 includes additional, fewer, or different components.

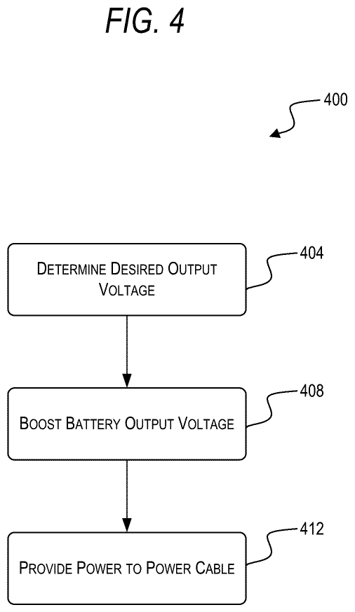

FIG. 4 is flowchart illustrating a battery pack operation process 400 implemented by the controller 220 of the battery pack 104, according to some embodiments. During operation of the battery pack 104, the controller 220 determines a desired output voltage of the power output interface 212 (STEP 404). The controller 220 may determine the desired output voltage using any of the methods described above with reference to FIG. 2 (e.g., based on user input, based on communication from the power tool 108, based on a predetermined value, based on a communication over the network 268, etc.). The controller 220 then controls the voltage boosting circuit 216 to boost the first voltage collectively output by the plurality of battery cells 204 to a second voltage approximately equal to the determined desired output voltage (STEP 408). The second voltage is then provided to the power cable 112 via the power output interface 212 and is transmitted to the power tool 108 (STEP 412).

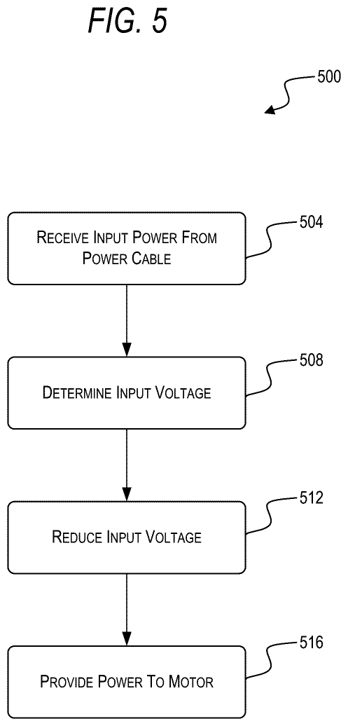

FIG. 5 is a flowchart illustrating a power tool operation process 500 implemented by the controller 320 of the power tool 108, according to some embodiments. During operation of the power tool 108, the power input interface 304 receives power from the battery pack 104 via the power cable 112 (STEP 504). Using, for example, one or more voltage sensors included in the power tool 108, the controller 320 determines the voltage received at the power input interface 304 (STEP 508). The controller 320 then controls the voltage reduction circuit 308 to reduce the received voltage to a desired voltage for operation of the power tool 108 (e.g., the nominal voltage of the battery pack 104) (STEP 512). The voltage reduction circuit 308 then provides power at the reduced voltage to the motor 312, and the controller 320 controls operation of the motor 312 via the switching circuit 334 (STEP 516).

Although aspects of the present disclosure have been described in detail with reference to certain embodiments, variations and modifications exist within the scope and spirit of one or more independent aspects as described. Various features of the disclosure are set forth in the following claims.

What is claimed is:

1. A power tool system comprising:
a battery pack having a first voltage, the battery pack including:
a power output interface,
a plurality of battery cells configured to output the first voltage, and
a voltage boosting circuit electrically connected to the plurality of battery cells, the voltage boosting circuit configured to receive the first voltage and output a second voltage to the power output interface;
a power tool including:
a motor,
a power input interface configured to receive the second voltage, and
a voltage reduction circuit configured to receive the second voltage from the power input interface and provide a third voltage to the motor; and
a power cable configured to transmit power from the power output interface of the battery pack to the power input interface of the power tool.

2. The power tool system of claim 1, wherein the battery pack further includes a battery pack controller configured to:
receive a signal from the power tool via the power cable, the signal indicative of a value of the second voltage;
determine the second voltage based on the signal; and
control the voltage boosting circuit to output the second voltage.

3. The power tool system of claim 1, wherein the battery pack further includes a battery pack controller configured to:
determine whether the battery pack is directly electrically connected to the power tool or electrically connected to the power tool via the power cable; and
control, in response to determining that the battery pack is electrically connected to the power tool via the power cable, the voltage boosting circuit to output the second voltage such that the second voltage is greater than the first voltage.

4. The power tool system of claim 3, wherein the battery pack controller is further configured to:
control, in response to determining that the battery pack is directly electrically connected to the power tool, the voltage boosting circuit to output the second voltage such that the second voltage is approximately equal to the first voltage of the battery pack.

5. The power tool system of claim 1, further comprising:
a communication network;
wherein the battery pack further includes a battery pack controller configured to:
receive a user input via the communication network,
determine the second voltage of the battery pack based on the user input, and
control the voltage boosting circuit to output the second voltage.

6. The power tool system of claim 1, wherein the third voltage is approximately equal to the first voltage of the battery pack.

7. The power tool system of claim 1, wherein:
the second voltage is greater than the first voltage, and
the third voltage is less than the second voltage.

8. The power tool system of claim 1, wherein the third voltage is approximately equal to a nominal voltage of the power tool.

9. The power tool system of claim 1, wherein the first voltage is approximately equal to a nominal voltage of the battery pack.

10. The power tool system of claim 1, wherein:
a first end of the power cable is removably connectable to the power output interface of the battery pack; and
a second end of the power cable is removably connectable to the power input interface of the power tool.

11. A power tool system comprising:
a battery pack including:
a power output interface,
a plurality of battery cells collectively configured to output a first voltage, and
a voltage boosting circuit electrically connected between the plurality of battery cells and the power output interface, the voltage boosting circuit configured to receive the first voltage and output a second voltage;
a power tool including:
a motor,
a power input interface configured to receive a third voltage, and
a voltage reduction circuit electrically connected between the power input interface and the motor, the voltage reduction circuit configured to receive the third voltage from the power input interface and provide a fourth voltage to the motor; and
a power cable configured to transmit power from the power output interface of the battery pack to the power input interface of the power tool.

12. The power tool system of claim 11, wherein the third voltage is less than or equal to the second voltage and greater than the first voltage.

13. The power tool system of claim 11, wherein the second voltage is greater than the first voltage and the fourth voltage.

14. The power tool system of claim 11, wherein the fourth voltage is approximately equal to the first voltage.

15. A method for controlling a power tool system, the method comprising:
outputting, with a plurality of battery cells in a battery pack, a first voltage to a voltage boosting circuit;
receiving, at the voltage boosting circuit, the first voltage;
outputting, with the voltage boosting circuit, a second voltage to a power output interface of the battery pack;
transmitting power from the power output interface of the battery pack to a power input interface of a power tool;
receiving, with a voltage reduction circuit of the power tool, the second voltage from the power input interface;
outputting, with the voltage reduction circuit, a third voltage to a motor of the power tool; and
driving the motor with the third voltage.

16. The method of claim 15, further comprising:
receiving, with a battery pack controller, a signal from the power tool via a power cable, the signal indicative of a sensed value of the third voltage;
determining, with the battery pack controller, the second voltage based on the signal; and
controlling the voltage boosting circuit to output the second voltage.

17. The method of claim 15, further comprising:
receiving, with a battery pack controller, a command from the power tool via a power cable to modify the second voltage; and
controlling, with the battery pack controller, the voltage boosting circuit to output a modified second voltage based on the command.

18. The method of claim 15, further comprising:
determining, with a battery pack controller, whether the battery pack is directly electrically connected to the power tool or electrically connected to the power tool via a power cable; and
controlling, with the battery pack controller in response to determining that the battery pack is electrically connected to the power tool via the power cable, the voltage boosting circuit to output the second voltage such that the second voltage is greater than the first voltage.

19. The method of claim 18, further comprising:
controlling, in response to determining that the battery pack is directly electrically connected to the power tool, the voltage boosting circuit to output the second voltage such that the second voltage is approximately equal to the first voltage of the battery pack.

20. The method of claim 15, further comprising:
receiving, with a battery pack controller, a user input via a communication network;
determining, with the battery pack controller, the second voltage of the battery pack based on the user input; and
controlling, with the battery pack controller, the voltage boosting circuit to output the second voltage.
